(19) United States
(12) Patent Application Publication
(10) Pub. No.: US 2010/0316757 A1
(43) Pub. Date: Dec. 16, 2010

(54) DEVICE FOR INJECTING COMPRESSED AIR INTO A BLOW MOULD

(75) Inventor: Othmar Rymann, Balterswil (CH)

Correspondence Address: VENABLE LLP, P.O. BOX 34385, WASHINGTON, DC, 20043-9998, US

(73) Assignee: Eugen Seitz AG, Wetzikon (CH)

(21) Appl. No.: 12/866,277

(22) PCT Filed: Feb. 5, 2008
(86) PCT No.: PCT/EP08/51421

§ 371 Date: Aug. 5, 2010

(51) Int. Cl. B29C 49/12; B29C 49/58

(52) U.S. Cl. 425/529

(57) ABSTRACT

The invention relates to a device for injecting compressed air into a parison, having an injection cylinder, having a hollow shaft arranged inside the housing of the injection cylinder in a manner so as to be displaceable along its longitudinal axis (A), one end of said hollow shaft projecting out of the housing and provided with a connection head for the tight connection to the parison, and having a stretching rod arranged coaxially to the hollow shaft in the interior of the hollow shaft and displaceable coaxially with the hollow shaft. A double piston is arranged axially parallel to the hollow shaft. The double piston is connected to the hollow shaft by a connection lug and thereby moves the hollow shaft along its longitudinal axis (A) between a lower and an upper end position. According to the invention, the active surfaces of the double piston are each arranged in a control chamber connected to a separate control line, which are configured in the housing of the injection cylinder.

The present invention relates to a device according to the preamble of claim 1 as well as a blowing unit having such a device.

In order to produce plastic bottles, in particular PP bottles and PET bottles, a blank or parison is usually blown into its final shape in two steps in a blow-moulding machine. For this purpose the blank already substantially comprises the finished bottle head which is held in the blow mould of the blow moulding machine and connected to a compressed air system via an injection cylinder. By injecting compressed air through the bottle head the blank is inflated and ultimately brought into its final shape.

This blowing process is usually carried out in a two-stage process wherein a pre-blowing with a pressure between 2 and 20 bar is carried out via a pre-blowing valve and then in a second stage, the final blowing, i.e. the shaping of the plastic bottle into its final shape, is carried out with a pressure between 15 to 40 bar via a main blowing valve. These two valves are each connected to a pressure source of a compressed air system with the pressure potential corresponding to the appropriate process stage.

In order to ensure economic production, these processes must take place as quickly as possible. For this purpose a valve arrangement consisting of two valves, a pre-blowing valve and a blowing valve, is conventionally used, which valves are arranged for example on a common block.

Following these two blowing stages, the connection to the pressure sources must be interrupted and the pressure released from the plastic bottle and from the feed channels before the plastic bottle can be removed from the blow mould connected to the injection cylinder. This process step is also designated as venting.

A stretching rod is conventionally used to assist the blowing process, which stretching rod is arranged axially displaceably in the injection cylinder and is inserted into the blank or the plastic bottle during the blowing process. This stretching rod is driven by an additional drive, frequently pneumatic or electrical. In this case, the stretching rod moves from its initial position inside the injection cylinder in a first section in the direction of the blank, through the head thereof as far as the base thereof and thereafter in a second section together with the injection of the blowing air, moves with the base as far as the final position of the base of the plastic bottle relative to the injection cylinder. During the venting phase the stretching rod is withdrawn back into its initial position again.

The two said sections are either passed through in sequence or divided into two sequences in accordance with the sections described.

The injection cylinder has a so-called blowing nozzle as the outlet opening, which must be brought tightly into communication with the head of the blank. For this purpose the blowing nozzle is conventionally arranged on a hollow shaft arranged in the injection cylinder in a manner so as to be axially displaceable with respect to the stretching rod. The lower side serves in this case as a sealing surface against the blank or the head of the blank. The hollow shaft is thereby pneumatically driven or moved by means of a radially outwardly projecting flange, which serves as a double-acting ring piston, via correspondingly configured pressure chambers inside the injection cylinder. Towards the injection cylinder the head frequently has a cushioning ring which serves as a stop when withdrawing the hollow shaft at the end of the venting phase and in so doing must cushion the entire mass of the hollow shaft. This cushioning ring is usually arranged on the outside of the hollow shaft and is thereby visible from outside for inspection purposes.

As a result of this arrangement of the flange or ring piston of the hollow shaft, the injection cylinder radially has a very large housing in the region of the ring piston which is very complex to process due to the different diameters distributed in the axial direction, which is associated with high manufacturing costs. The injection cylinder is therefore also highly gradated in its axial direction and has a relatively high space requirement. Furthermore, in particular the movement or the upper end stop of the hollow shaft in the injection cylinder can only be very poorly cushioned which has a negative effect on the lifetime of the cushioning ring and also limits the effective working speed.

The German laid-open patent application DE 1 561 985 discloses a device for producing packages from thermoplastic plastic comprising a sleeve 20 and a rod 45 running therein. For displacing the sleeve 20, there is provided a working cylinder 48 arranged axially parallel thereto, the piston rod 49 thereof acting on its upper end.

It was now the object of the present invention to find an injection cylinder of this type in which the hollow shaft is driven in a simpler and more space-saving manner.

This object is achieved according to the invention by a device having the features according to claim 1. Further embodiments in accordance with the invention are obtained from the features of the further claims 2 to 10.

In a device for injecting compressed air into a parison, comprising an injection cylinder, comprising a hollow shaft arranged inside the housing of the injection cylinder in a manner so as to be displaceable along its longitudinal axis, one end of said hollow shaft projecting out of the injection cylinder and provided with a connection head for a tight connection to the parison, and comprising a stretching rod arranged coaxially to the hollow shaft in the interior of the hollow shaft and displaceable coaxially to the hollow shaft, in accordance with the invention a double piston is arranged axially parallel to the hollow shaft which double piston is connected to the hollow shaft by a connection lug and thereby moves the hollow shaft along its longitudinal axis between a lower and an upper end position. The drive of the hollow shaft therefore no longer takes place coaxially, but rather from the side via a piston axis arranged parallel to the longitudinal axis of the hollow shaft. In this way, the functioning of the air supply via the hollow shaft and the movement of the coaxially arranged stretching rod is separated from the drive of the hollow shaft. On the one hand this has the result that the space requirement of the injection cylinder is varied in the cross-section, since the radial space requirement is reduced around the hollow shaft since the ring piston is omitted but on the other hand an increased space requirement for the drive is only required radially in one direction. Consequently, the space requirement of the injection cylinder is slimmer, at least in one extension which is advantageous for the arrangement of the device on stretch blow moulding machines.

In accordance with the invention, the two active surfaces of the double piston are each arranged in a control chamber connected to a separate control line, which are configured in the housing of the injection cylinder. The two control chambers are in this case preferably arranged coaxially in the housing and have the same diameter and can therefore simply be manufactured or processed in one operation.

For example, the double piston is formed from two single pistons each having one control surface and the opposite side is in each case connected to or in contact with the connecting lug. Thus two identical pistons can be used which simplifies both the manufacture and the assembly.

For example, the double piston or the individual pistons consist at least partially of plastic, preferably consist completely of plastic. The drive of the hollow shaft can therefore be implemented using two simple plastic pistons which can be produced inexpensively. A further advantage is the relatively low weight of the plastic piston whereby the dynamic mass and therefore the inertia becomes smaller and can thus be damped more efficiently and simply.

For example, the connecting lug is connected in one piece positively and non-positively to the hollow shaft and/or the double piston or the piston. The movement of the pistons is therefore transmitted reliably and precisely to the hollow shaft with little space requirement.

For example, the connecting lug is configured as a straight component and comprehensively encompasses the hollow shaft, wherein the hollow shaft has an external thread for receiving the connecting lug. The external thread can thereby be simply attached to the outer wall of the hollow shaft which can advantageously be made of rod material. The hollow shaft can thus be screwed from below into the lug located in the housing of the injection cylinder and the connection can be fixed in a torsion-proof manner by means of a safety bolt which is guided through the connecting lug into the outer wall of the hollow shaft.

For example, a shock absorber is arranged in the injection cylinder which comes to abut against the connecting lug. Since the connecting lug is moved parallel to the hollow shaft, its movement can likewise be optimally cushioned by a cushioning acting on the connecting lug. An effective hydraulic shock absorber can be arranged in a space-saving manner between the hollow shaft and the double piston and, for example, can act particularly effectively on the connecting lug approximately at its centre between the hollow shaft and the double piston.

For example, the shock absorber is arranged and designed in such a manner that it only comes to abut against the connecting lug following a partial lifting movement of the hollow shaft from the upper end position towards its lower end position inside the injection cylinder. In the upper end position of the hollow shaft, the rest position of the hollow shaft, this is inserted almost completely into the injection cylinder and separated from the parison. In this position, for example, a gripper of the stretch blow moulding machine can be inserted between injection cylinder and blow mould, and can grip the parison located in the blow mould or the finish-blown bottle on the bottle thread and insert or remove it. If the hollow shaft is now moved downwards for the blowing process into its working position in which it enters into tight abutment with the blow mould upper side or the bottle thread, the connecting lug only comes into abutment with the shock absorber after a certain path or stroke of the hollow shaft, i.e., the beginning of the downward movement takes place in an uncushioned manner. This can advantageously be used for so-called HOTFILL applications where the first stroke distance should be run through as fast as possible but before the impingement of the lower side of the hollow shaft on the upper side of the thread of the parison, the movement should be slowed or cushioned since the thread of the parison is hot and therefore soft in this method. Due to the cushioning element the movement here can be retarded just shortly before contacting the thread of the parison and therefore any deformation of the thread can be avoided. Advantageously for this purpose a second control valve for the double piston can be dispensed with as is the case in conventional devices.

For example, the connecting lug is connected to a bolt guided axially parallel to the longitudinal axis of the hollow shaft. The bolt prevents any twisting of the connecting lug and therefore in particular any twisting of the hollow shaft about its longitudinal axis.

For example, the housing of the injection cylinder has a rectangular cross-section. The housing can thus be made of a simple rod material which lowers the production costs compared with conventional devices. By eliminating the ring piston surfaces on the hollow shaft, this can also be made simply of rod material which again contributes towards the lowering of the production costs of the injection cylinder.

Further proposed according to the invention is a blowing unit comprising a blowing cylinder according to the invention with a blowing block arranged laterally directly on a longer cross-sectional side and a feed line opening into the front side of the blowing block, directly adjacent to the shorter cross-sectional side of the injection cylinder in the region of the hollow shaft or the stretching rod. An extremely compact design in cross-section is therefore achieved with very short flow paths inside the individual elements of the blowing unit, whereby performance losses due to flow losses are reduced or avoided.

For example, a throttling valve is arranged either laterally on the blowing block or laterally on the housing of the injection cylinder. A large part of the working air or the working pressure can thus be recovered.

Exemplary embodiments of the present invention are explained in detail hereinafter with reference to figures. In the figures:

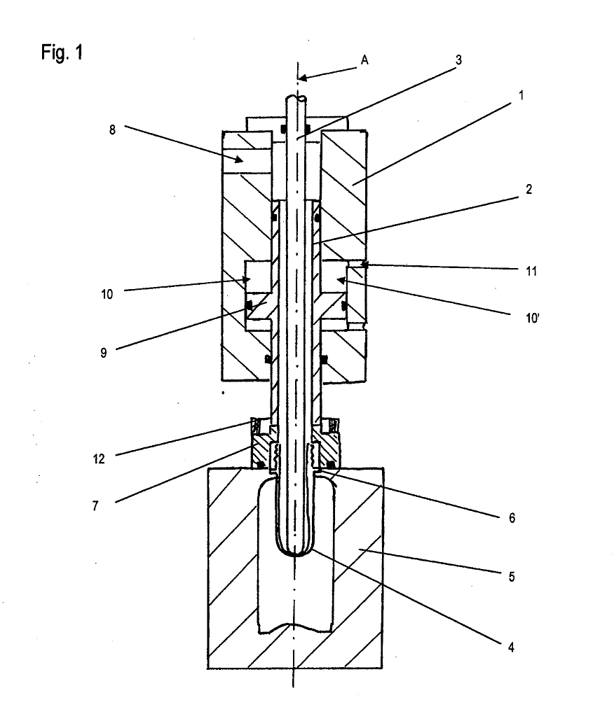

FIG. 1 shows purely schematically a longitudinal section through a conventional injection cylinder;

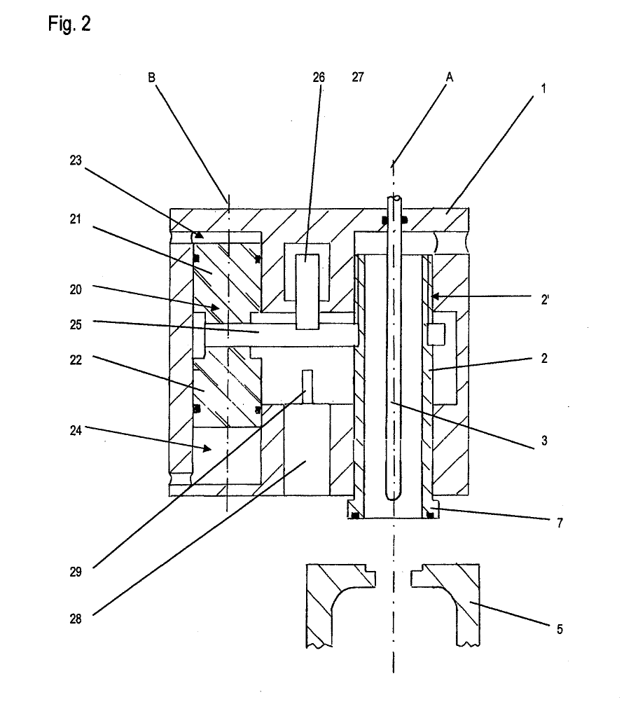

FIG. 2 shows schematically a longitudinal section through a device according to the invention in the rest position of the hollow shaft;

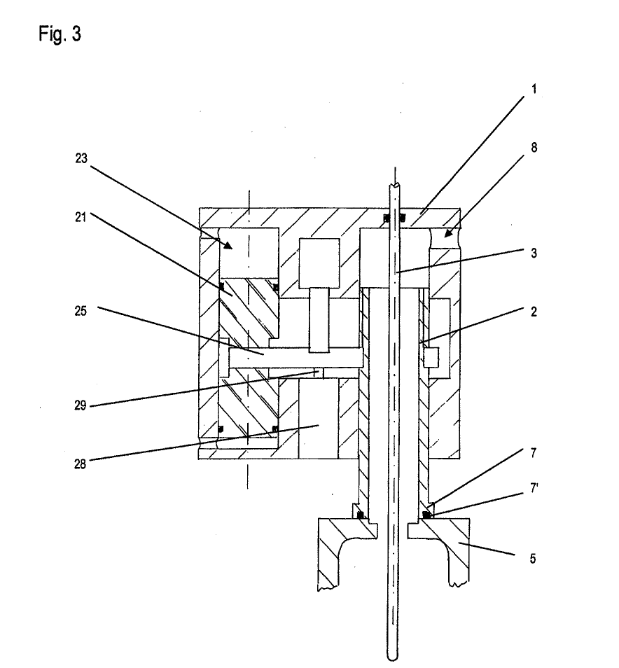

FIG. 3 shows schematically the longitudinal section according to FIG. 2 in the working position of the hollow shaft;

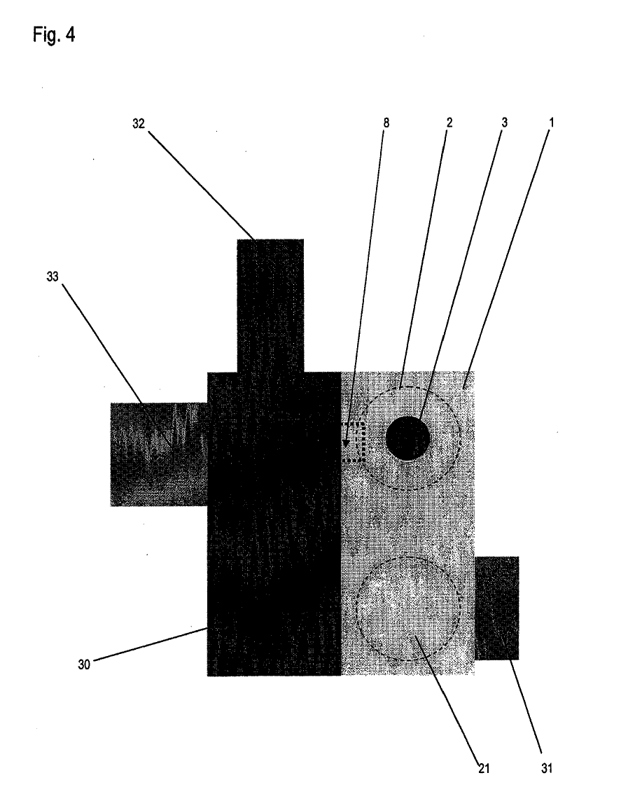

FIG. 4 shows purely schematically the plan view of a blowing station fitted with an injection cylinder according to the invention; and

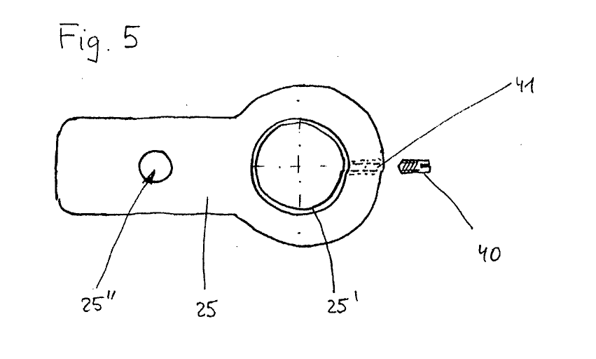

FIG. 5 shows the plan view of the lug of the device according to the invention from FIG. 2.

FIG. 1 shows purely schematically a longitudinal section through a conventional injection cylinder of a stretch blow moulding machine for producing, for example, PET bottles. A stretching rod 3 is arranged in the housing 1 coaxially to the hollow shaft 2. The stretching rod 3 leads out at the top of the housing 1 to a separate drive (not shown) of the stretching rod 3. In the lowered state the lower end of the stretching rod 3 opens into the parison 4 of the PET bottle to be blown which for its part is held in the blow mould 5 by means of a neck ring 6.

At its lower end the hollow shaft 2 has a sealing bell 7 which in the example shown in the working position of the hollow shaft 2 is in sealing contact with the upper side of the blow mould 5. Via the pressure line 8 blowing air can now be blown downwards into the parison via the hollow shaft 2 and this can be injected according to the shape of the blow mould 5 to its final shape. Thereafter both the stretching rod 3 and also the hollow shaft 2 are drawn upwards into their rest position.

The hollow shaft 2 is thereby driven via its flange 9 configured as a ring piston, which lies in a control chamber 10 arranged coaxially to the hollow shaft 2.

For this purpose for the working position the upper control chamber 10′ is coupled to compressed air via the control line 11 and thus moved downwards.

For cushioning the movement into the rest position, a cushioning ring 12 is arranged on the sealing bell 7 on its side directed towards the injection cylinder. This cushioning ring 12 must cushion the entire mass of the hollow shaft 2, in particular therefore also the mass of the flange 9. It is apparent from this arrangement that a plurality of cylindrical chambers having different diameters and arranged coaxially to the longitudinal axis A of the hollow shaft 2 are formed in the housing 1 of the injection cylinder, which are very complex to manufacture and which crucially predetermine the external dimensions or the cross-sectional area of the injection cylinder.

FIG. 2 also shows purely schematically a longitudinal section through a device according to the invention. The hollow shaft 2 is arranged inside the housing 1 of the injection cylinder in a manner so as to be displaceable along its longitudinal axis A and the stretching rod 3 is also arranged coaxially in its interior.

The drive of the hollow shaft 2 is now not effected by a ring flange but by a double piston arrangement 20 which is arranged axially parallel to the axis A laterally in the housing 1. For example, it is configured with an upper piston 21 and a lower piston 22 which are each arranged in a manner acting coaxially to one another in a piston chamber 23 or 24 and act on a connecting lug 25 which for its part is connected form-fitting and force-fitting to the hollow shaft 2.

In the rest position of the injection cylinder shown the piston 21 is in its upper position and the piston 22 is in its upper position by supplying pressure into the piston chamber 24, whereby the hollow cylinder is held in its upper rest position. The sealing bell 7 is thus positioned in a manner raised from the blow mould 5.

The sealing bell 7 is, for example, detachably connected to the hollow shaft 2 as a replacement part as is conventionally known and on its lower side has seals for abutting against the upper side of the blow mould 5. The sealing bell 7 can also be configured for abutting against the neck ring (not shown) of the parison (not shown) held in the blow mould 5.

The connecting lug 25 is, for example, screwed to said hollow shaft by means of a thread 2′ into the outer wall of the hollow shaft 2 and is thereby connected form-fitting and force-fitting. The thread 2′ as an external thread can be attached by simple production technology to the hollow shaft which can advantageously be made of rod material since no externally projecting flanges need be formed.

Any twisting of the connecting lug 25 about the longitudinal axis A of the hollow shaft 2 is prevented by the bolt 26 which is guided via a guide 27 in the housing 1 of the injection cylinder.

A hydraulic cushioning element 28 is arranged in the housing 1 of the injection cylinder underneath, approximately at the centre of the connecting lug 25. By means of a contact pin 29 the cushioning element 28 can be brought into contact with the connecting lug 25 and thereby cushion the downwards movement of the connecting lug 25. The contact pin 29 is thereby pressed into the interior of the cushioning element whose cushioning characteristic is either fixedly predefined or adjusted or is adjustable. If the connecting lug 25 is, for example, made from a light metal, the bolt 26 can be guided through the connecting lug 25 and aligned coaxially to the contact pin 29. As a result, the contact of the tip of the contact pin 29 does not take place directly onto the outer wall of the connecting lug 25 but via the lower end of the bolt 26, wherein both contact pin 29 and bolt 26 can be made of low-wear steel.

In FIG. 3 the hollow shaft 2 is shown in its working position, i.e. in its lower position with the sealing bell 7 impacting on the upper side of the blow mould 5. The seal is achieved in this case by a sealing ring 7′ which is arranged in a peripheral groove of the sealing bell 7.

The stretching rod 3 is also lowered further downwards and extends into the blow mould 5 or as far as the base of the parison (not shown). The blowing air is fed via the feed line 8 through the hollow shaft 2 likewise into the blow mould 5 or the parison (not shown) and inflates this to its final shape according to the shape of the blow mould 5.

The movement of the hollow shaft 2 has thereby been triggered by the piston 21 which on its active side is exposed to a corresponding control pressure in the piston chamber 23 and thereby presses the connecting lug 25 downwards and consequently also the hollow shaft 2.

Due to the downward movement the connecting lug 25 comes in contact with the contact pin 29 of the cushioning element 28 and presses this downwards, whereby the cushioning effect is initiated and the movement slowed. On the one hand, a short closure time of the hollow shaft 2 can thus be achieved and on the other hand, the closing contact between the sealing bell 7 and the upper side of the blow mould 5 nevertheless proceeds relatively gently.

This is particularly advantageous if a sealing bell 7 is used which does not come in contact with the upper side of the blow mould but with the upper edge of the closure of the parison, as is the case in the HOTFILL method mentioned initially in which the closure is soft due to heating and can thus be deformed by too-strong closure forces.

Any axial twisting of the hollow shaft 2 is prevented by the bolt 26 guided in the housing 1. Thus, the sealing bell 7 can be connected to the hollow shaft 2 with a screw connection, whereby no counter hold device on the hollow shaft 2 is necessary for tightening and releasing this screw connection, this can be achieved merely by acting on the sealing bell 7 which is configured with correspondingly positive active surfaces.

FIG. 4 shows purely schematically a plan view of a blowing unit according to the invention with an injection cylinder according to the invention. The housing 1 of the injection cylinder in this case has a rectangular cross-section with a narrow front. A blowing block 30 with the control valves for controlling the blowing air can thus be arranged laterally on the longer side. As a result, an overall rectangular or square cross-section is obtained which can be optimally integrated into the blowing station. From the outer side of the blowing station, i.e. from the access side from outside, the region of the control piston 21 is advantageously accessible, the corresponding control valves 31 with short control lines being arranged on the side thereof. The blowing block can be connected to the feed line 32 of the blowing air from the machine side, usually the centre of the blowing wheel on which the blowing stations are arranged radially and the exhaust air and optionally the outlet of a throttling valve 33 can be arranged thereon. As a result, optimally short feed and control lines can be achieved which enhance the efficiency and therefore the performance of the entire machine.

The throttling valve 33 can also be arranged on the right side of the housing 1 of the injection cylinder and thus come to rest on the same side as the control valves 31, thereby further reducing the lateral space requirement of the blowing unit.

FIG. 5 again shows in further detail the connecting lug 25 in plan view. In the area of the connection to the hollow shaft 2 the connecting lug 25 has a closed ring with an internal thread 25′ into which the external thread 2′ of the hollow shaft 2 is screwed. A safety bolt 40 is further provided for preventing rotation of the screw connection, which bolt is screwed into a screw hole 41 radially to the axis A of the hollow shaft 41 and comes into abutment against the hollow shaft 2 or engages in a blind hole there and thereby fixes the screw connection in a torque-proof manner. The recess 25″ for receiving the bolt 26 can be further seen in FIG. 5 which, for example, can also be fitted with an internal thread.

1. A device for injecting compressed air into a parison, comprising an injection cylinder, comprising: a hollow shaft arranged inside the housing the injection cylinder in a manner so as to be displaceable along its longitudinal axis (A), one end of said hollow shaft projecting out of the housing and provided with a connection head for a tight connection to the parison, and comprising a stretching rod arranged coaxially to the hollow shaft in the interior of the hollow shaft and displaceable coaxially with the hollow shaft, wherein a double piston is arranged axially parallel to the hollow shaft which is connected to the hollow shaft by a connection lug and thereby moves the hollow shaft along its longitudinal axis (A) between a lower and an upper end position, characterised in that the active surfaces of the double piston are each arranged in a control chamber connected to a separate control line, which are configured in the housing of the injection cylinder.

2. The device according to claim 1, wherein the double piston is formed from two single pistons each having one control surface and the opposite side is in each case connected to or in contact with the connecting lug.

3. The device according to claim 1, wherein the double piston or the individual pistons consist at least partially of plastic, preferably consist completely of plastic.

4. The device according to claim 1, wherein the connecting lug is connected in one piece form-fitting and force-fitting to the hollow shaft and/or the double piston or the piston.

5. The device according to claim 1, wherein the connecting lug is configured as a straight component and comprehensively encompasses the hollow shaft, wherein the hollow shaft has an external thread for receiving the connecting lug.

6. The device according to claim 1, wherein a shock absorber is arranged in the injection cylinder which comes to abut against the connecting lug.

7. The device according to claim 6, wherein the shock absorber is arranged and designed in such a manner that it only comes to abut against the connecting lug following a partial lifting movement of the hollow shaft from the upper end position towards its lower end position inside the injection cylinder.

8. The device according to claim 1, wherein the connecting lug is connected to a bolt guided axially parallel to the longitudinal axis (A) of the hollow shaft.

9. The device according to claim 1, wherein the housing of the injection cylinder has a rectangular cross-section.

10. A blowing unit comprising a blowing cylinder according to claim 9 with a blowing block arranged laterally directly on a longitudinal cross-sectional side and a feed line opening into the front side of the blowing block, directly adjacent to the shorter cross-sectional side of the injection cylinder in the region of the hollow shaft or the stretching rod.

11. The blowing unit according to claim 10, wherein a throttling valve is arranged either laterally on the blowing block or laterally on the housing of the injection cylinder.
